(19) United States
(12) Patent Application Publication
(10) Pub. No.: US 2010/0124909 A1
(43) Pub. Date: May 20, 2010

(54) APPARATUS AND METHOD FOR MESSAGE TRANSMISSION IN A MOBILE COMMUNICATION SYSTEM

(75) Inventor: Sang-Woo Lee, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/578,781

(22) Filed: Oct. 14, 2009

(30) Foreign Application Priority Data
Nov. 20, 2008 (KR) 10-2008-0115610

(51) Int. Cl. H04L 12/58; H04W 4/00

(52) U.S. Cl. 455/412.2; 455/412.1; 455/466

(57) ABSTRACT

An apparatus and method for message transmission in a mobile communication system are provided. The apparatus includes an application manager and a message processor. The application manager determines an application corresponding to a receive message, sends the receive message to the determined application, and determines a response to the message reception from the application. The message processor sets a response informing that a message is delivered to the application or a response informing that a message is not delivered to the application depending on an operation of the application manager.

### PRIORITY

This application claims the benefit under 35 U.S.C. §119(a) of a Korean patent application filed in the Korean Intellectual Property Office on Nov. 20, 2008 and assigned Serial No. 10-2008-0115610, the entire disclosure of which is hereby incorporated by reference.

### BACKGROUND OF THE INVENTION

1. Field of the Invention

The present invention relates to an apparatus and method for message transmission in a mobile communication system. More particularly, the present invention relates to an apparatus and method for, upon multimedia message transmission, providing an interface state between a multimedia message and a corresponding application in a mobile communication system.

2. Description of the Related Art

When first introduced, a portable terminal provided a user with the ability to perform wireless communication with mobility. However, with advances in mobile communication technology and the introduction of the wireless Internet, the portable terminal can now realize not only simple telephone service or function such as schedule management but can also perform various advanced applications such as games, remote control of short-range communication, and image capturing using an embedded digital camera, thus meeting the desires of users.

One such advanced function is the short message function. The short message function is widely used because of its lower cost as compared to voice telephony.

Beyond the simple text message provided by the short message function, a Multimedia Message Service (MMS) delivers a message that may include a moving picture, a photograph, a music file, and so on. The MMS is a representative wired/wireless integrated service with advantages of the short message service, the electronic mail (e-mail) service, and the like. The MMS may include and provide multimedia content and thus, is frequently used by portable terminal users within and outside the country.

The MMS may compositely construct and transmit/receive texts, music, images, moving pictures, link information, and the like. Through the MMS, a user can send a digital postcard, a picture, a moving picture, a moving picture card, a map, a business card, and the like.

Regarding the MMS, the ‘MMS 1.3 specification’ provides a definition to enable transactions between a multimedia message and an application, by newly adding three fields of an ‘Applic-Identification (ID)’, a ‘ReplyApplic-ID’, and an ‘Aux-Applic-Info’. The three fields related to the application are used in MMS Protocol Data Units (MMS PDUs) of an ‘M-Send.req’, an ‘M-Notification.ind’, an ‘M-Retrieve.con’, an ‘M-Delivery.ind’, an ‘M-Read-Rec.ind’, and an ‘M-Read-Orig.ind’, and are devised to deliver information on multimedia message transmission/reception.

However, it may occur that, after receiving a multimedia message, the portable terminal fails to deliver the received multimedia message to each application because an application requiring a delivery of the multimedia message (i.e., an application related to the multimedia message) is not registered in the portable terminal or because of an internal problem, etc.

Accordingly, there is a problem that, despite that the portable terminal sending the multimedia message does not deliver the sent multimedia message according to the original purpose, it is recognized as if the portable terminal successfully delivers the multimedia message to an intended application since a transmission completion is indicated in an “MMS delivery report”.

In other words, the outgoing portable terminal may determine transmission/reception of the multimedia message itself to operate a specific application but cannot determine actual delivery or non-delivery to the application and thus, there is a problem that the outgoing portable terminal continuously sends an unnecessary multimedia message to an incoming portable terminal.

Thus, there is a need for an apparatus and method for, upon multimedia message transmission, determining an interface state between a multimedia message and a corresponding application in a mobile communication system providing the multimedia message service.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for, upon multimedia message transmission, determining an interface state between a multimedia message and a corresponding application in a mobile communication system.

Another aspect of the present invention is to provide an apparatus and method for identifying if a multimedia message is successfully delivered to a corresponding application in a mobile communication system.

Still another aspect of the present invention is to provide an apparatus and method for generating information indicative of delivery or non-delivery of a multimedia message in a mobile communication system.

The above aspects are addressed by providing an apparatus and method for message transmission in a mobile communication system.

In accordance with an aspect of the present invention, an apparatus for message transmission in a mobile communication system is provided. The apparatus includes an application manager and a message processor. The application manager determines an application corresponding to a receive message, sends the receive message to the determined application, and determines a response to the message reception from the application. The message processor sets a response informing that a message is delivered to the application or a response informing that a message is not delivered to the application depending on an operation of the application manager.

In accordance with another aspect of the present invention, a method for message transmission in a mobile communication system is provided. The method includes determining an application corresponding to a receive message, sending the receive message to the determined application, if receiving a response to message reception from the application, setting a response informing that the message is delivered to the application, if not receiving a response to message reception from the application, setting a response informing that the message is not delivered to the application, and sending the set response to a message server.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating a construction of a portable terminal for processing message reception according to an exemplary embodiment of the present invention;

FIG. 2 is a flowchart illustrating a message reception process of a portable terminal according to an exemplary embodiment of the present invention;

FIG. 3 is a ladder diagram illustrating a message handling process of a mobile communication system according to an exemplary embodiment of the present invention;

FIG. 4 is a ladder diagram illustrating a message handling process of a mobile communication system according to an exemplary embodiment of the present invention; and

FIG. 5 is a ladder diagram illustrating a message handling process of a mobile communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and method for generating information for notifying if an incoming terminal receiving a multimedia message successfully delivers the received multimedia message to a corresponding application to determine an interface state between the multimedia message and the corresponding application at the time of multimedia message transmission.

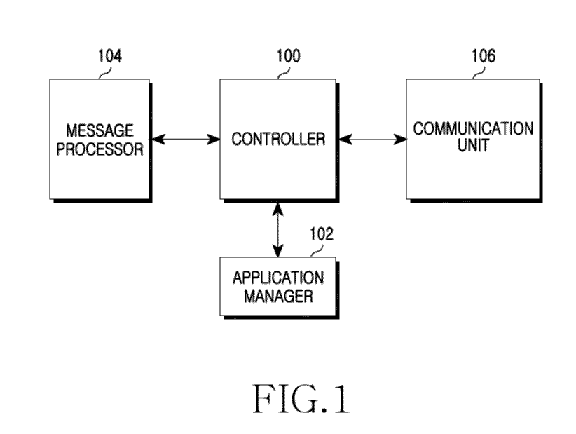

FIG. 1 is a block diagram illustrating a construction of a portable terminal for processing message reception according to an exemplary embodiment of the present invention.

Referring to FIG. 1, the portable terminal may include a controller 100, an application manager 102, a message processor 104, and a communication unit 106.

The controller 100 of the portable terminal controls a general operation of the portable terminal. For example, the controller 100 performs a process and control for voice telephony and data communication. In an exemplary implementation, the controller 100 performs a process for receiving a message transmitted by an outgoing terminal and, upon execution of the process, delivers the received message to a corresponding application.

After delivering the received message to the application corresponding to the message, the controller 100 determines if a response is received from the application and generates a message notifying of a transmission success or failure depending on the determination.

In an exemplary implementation, the controller 100 may determine a success or failure of message delivery to the application using the application manager 102, and may control the message processor 104 to generate a message that notifies of success or failure of message transmission to the application.

Under control of the controller 100, the application manager 102 processes to deliver a message, which is received from an outgoing terminal, to a corresponding application. Furthermore, the application manager 102 determines success or failure of delivery of the message to the corresponding application.

In an exemplary implementation, the application manager 102 may determine the success or failure of delivery of the message to the application based on reception or non-reception of a response from the application.

The message processor 104 performs an operation for receiving a multimedia message transmitted by the outgoing terminal. Also, according to an exemplary embodiment of the present invention, the message processor 104 generates a message notifying of the success or failure of the message delivery as determined by the application manager 102.

The communication unit 106 processes to transmit/receive a wireless signal input/output through an antenna (not shown). For example, in a transmission mode, the communication unit 106 channel-codes and spreads original data, converts the original data into a Radio Frequency (RF) signal, and transmits the RF signal. In a reception mode, the communication unit 106 converts a received RF signal into a baseband signal, de-spreads and channel-decodes the baseband signal, and restores original data.

In an exemplary embodiment of the invention, the above described functions of the application manager 102 and the message processor 104 may be performed by the controller 100 of the portable terminal. However, these are separately constructed and shown in FIG. 1 as an exemplary construction for description convenience with no limitation to the scope of the present invention. It will be understood by those skilled in the art that various modifications of construction may be made within the scope of the present invention. For example, construction may be such that the controller 100 processes all of these functions.

A description has been made above of an exemplary apparatus for notifying if an incoming terminal receiving a multimedia message successfully delivers the received multimedia message to a corresponding application to determine an interface state between the multimedia message and the corresponding application. The following description is made of an exemplary method for identifying if an incoming terminal receiving the multimedia message successfully delivers the received multimedia message to the corresponding application.

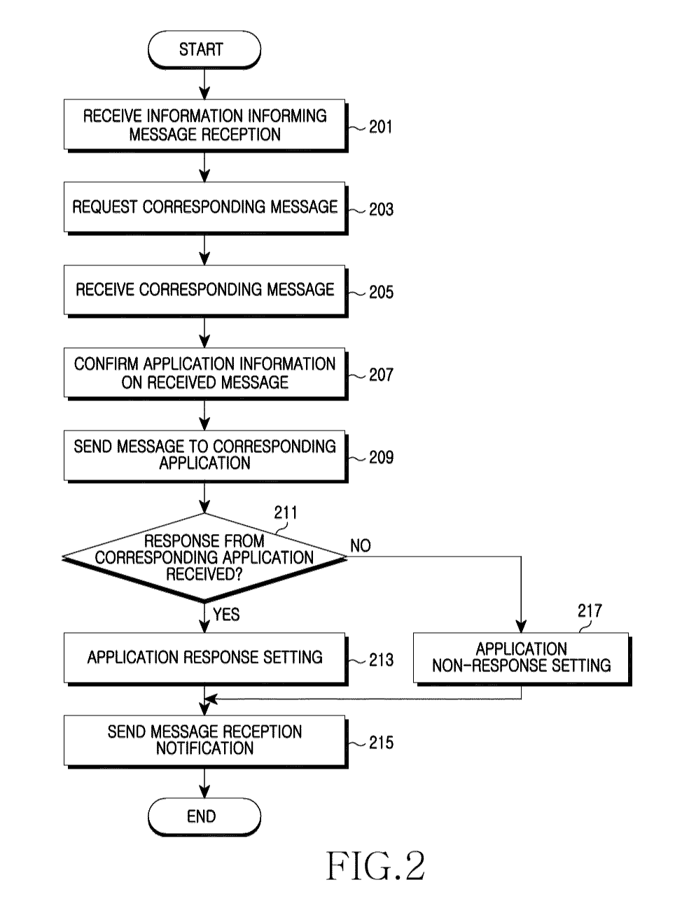

FIG. 2 is a flowchart illustrating a message reception process of a portable terminal according to an exemplary embodiment of the present invention.

Referring to FIG. 2, in step 201, the portable terminal receives information informing of message reception from a message server. In step 203, the portable terminal requests the message server to provide the corresponding message.

In step 205, the portable terminal receives the corresponding message from the message server and, in step 207, determines application information of the received message.

Here, the application information refers to information indicative of an application using the received message.

The portable terminal proceeds to step 209 and delivers the received message to a corresponding application using the determined application information.

In step 211, the portable terminal determines if a response is received informing that the corresponding application receives the message.

If the portable terminal determines that it has not received the response informing that the corresponding application receives the message in step 211, the portable terminal proceeds to step 217 and performs an application corresponding to a non-response setting. Here, the application non-response setting refers to setting information informing that an application does not receive a corresponding message.

On the other hand, if it is determined that the portable terminal has received the response informing that the corresponding application receives the message in step 211, the portable terminal proceeds to step 213 and performs an application corresponding to a response setting. Here, the application response setting refers to setting information informing that an application receives a corresponding message, contrary to the application non-response setting.

Then, the portable terminal proceeds to step 215 and sends a message reception or non-reception notification to the message server and then terminates the process.

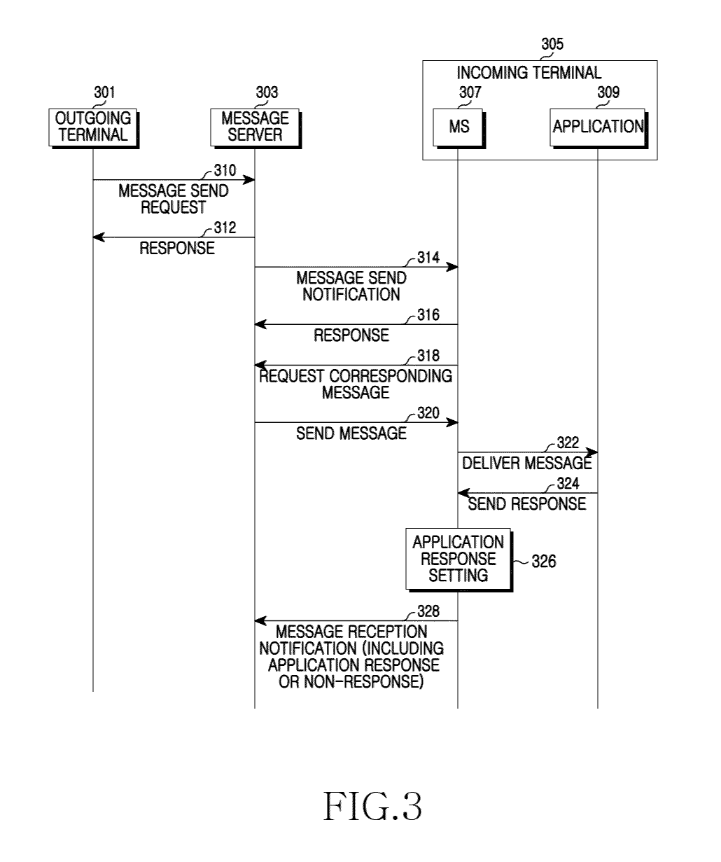

FIG. 3 is a ladder diagram illustrating a message handling process of a mobile communication system according to an exemplary embodiment of the present invention.

Referring to FIG. 3, the mobile communication system includes an outgoing terminal 301, a message server 303, and an incoming terminal 305. For ease of description, the incoming terminal 305 is considered as divided into an incoming Mobile Station (MS) 307 and a corresponding application 309. Here, the corresponding application 309 refers to an application using a received multimedia message.

If the outgoing terminal 301 intends to send a multimedia message to the incoming terminal 305, in step 310, the outgoing terminal 301 sends a message send request to the message server 303. Upon receiving the message send request, in step 312, the message server 303 sends a response to the request to the outgoing terminal 301.

In step 314, the message server 303 notifies the incoming terminal 305 that there is a message that the outgoing terminal 301 intends to send. In step 316, the incoming terminal 305 transmits a response to the notification to the message server 303. In step 318, the incoming terminal 305 sends a request for a corresponding message (i.e., the message that the outgoing terminal 301 intends to send) to the message server 303. If so, in step 320, the message server 303 sends the message requested by the incoming terminal 305 to the incoming terminal 305.

After receiving a multimedia message through the above process, in step 322, the incoming terminal 305 determines application information included in the received multimedia message and sends the multimedia message to the corresponding application 309 using the determined application information.

The above operation of the incoming terminal 305 is described in more detail below by considering the MS 307 and the application 309 separately constructed according to an exemplary embodiment of the present invention.

The multimedia message is received by the MS 307 of the incoming terminal 305. Upon receiving the multimedia message, in step 322, the MS 307 sends the received multimedia message to the corresponding application 309. Accordingly, in step 324, the application 309 sends a response to the message delivery to the MS 307 and, by doing so, in step 326, the incoming terminal 305 sets an application response.

Here, if the response to the message delivery is successfully received, the MS 307 performs an application response setting for informing that it receives an application response. If the response to the message delivery is not successfully received, the MS 307 performs an application non-response setting for informing that it does not receive an application response.

In step 328, the MS 307 sends a message reception notification including the application response or non-response to the message server 303.

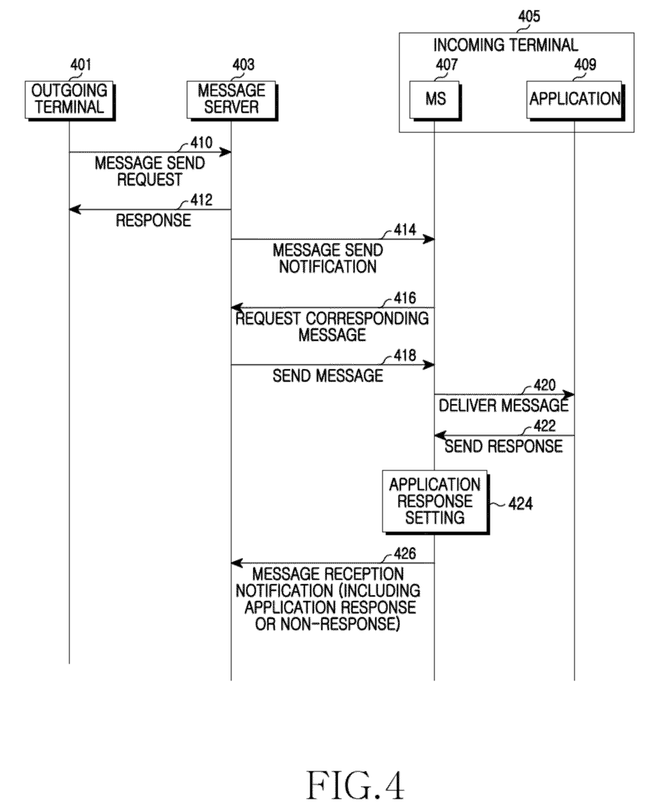

FIG. 4 is a ladder diagram illustrating a message handling process of a mobile communication system according to an exemplary embodiment of the present invention.

Referring to FIG. 4, the mobile communication system includes an outgoing terminal 401, a message server 403, and an incoming terminal 405. For ease of description, the incoming terminal 405 is described as divided into an incoming MS 407 and a corresponding application 409. Here, the corresponding application refers to an application using a received multimedia message.

If the outgoing terminal 401 intends to send a multimedia message to the incoming terminal 405, in step 410, the outgoing terminal 401 sends a message send request to the message server 403. Upon receiving the message send request, in step 412, the message server 403 sends a response to the request to the outgoing terminal 401.

In step 414, the message server 403 notifies the incoming terminal 405 that there is a message that the outgoing terminal 401 intends to send. If so, in step 416, the incoming terminal 405 sends a request for a corresponding message (i.e., the message that the outgoing terminal 401 intends to send) to the message server 403. In step 418, the message server 403 sends the message requested by the incoming terminal 405 to the incoming terminal 405.

After receiving a multimedia message through the above process, in step 420, the incoming terminal 405 processes to determine application information included in the received multimedia message and send the multimedia message to the corresponding application 409 using the determined application information.

The above operation of the incoming terminal 405 is described in more detail below by considering the MS 407 and the application 409 separately constructed according to an exemplary embodiment of the present invention.

The multimedia message is received by the MS 407 of the incoming terminal 405 in step 418. Upon receiving the multimedia message, in step 420, the MS 407 sends the received multimedia message to the corresponding application 409. Accordingly, in step 422, the application 409 sends a response to the message delivery to the MS 407 and, by doing so, in step 424, the incoming terminal 405 sets an application response.

Here, if successfully receiving the response to the message delivery, the MS 407 performs an application response setting for informing that it receives the application response. If not successfully receiving the response to the message delivery, the MS 407 performs an application non-response setting for informing that it does not receive the application response.

In step 426, the MS 407 sends a message reception notification including the application response or non-response to the message server 403.

FIG. 4 illustrates a process of, upon receiving information that there is a multimedia message that the outgoing terminal intends to send using the message server, directly requesting for a corresponding message. FIG. 3 illustrates a process of, upon receiving information that there is a multimedia message that the outgoing terminal intends to send, receiving a response for informing the information reception and then requesting for a corresponding message.

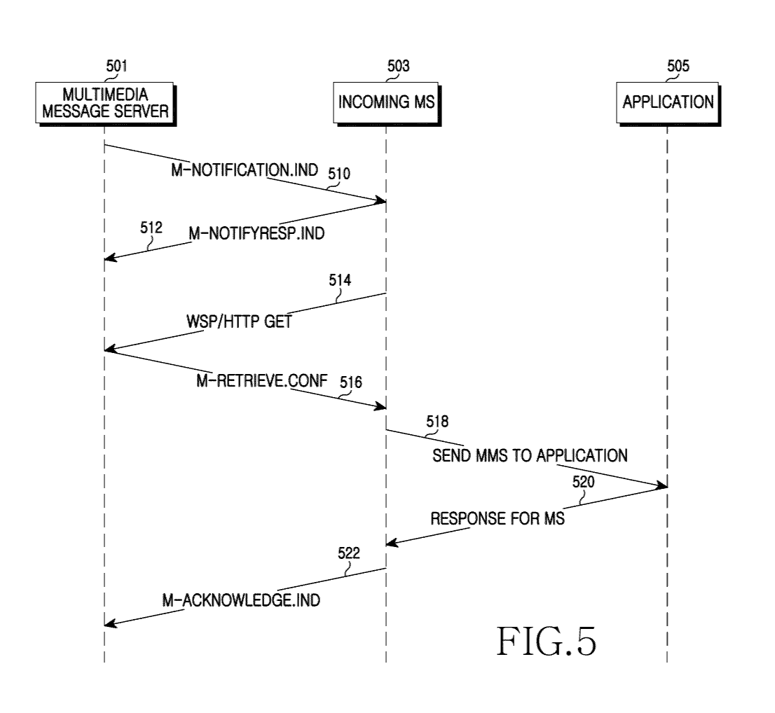

FIG. 5 is a ladder diagram illustrating a message handling process of a mobile communication system according to an exemplary embodiment of the present invention. A description of FIG. 5 is made assuming previously executing a process of requesting message transmission between an outgoing terminal and a message server.

Referring to FIG. 5, the mobile communication system includes a multimedia message server 501 and an incoming terminal. The incoming terminal includes an incoming MS 503 and an application 505.

Upon accepting (M-Send.conf) a multimedia message send request (M-Send.req) from an outgoing terminal, in step 510, the multimedia message server 501 sends an indicator message (M-Notification.ind) notifying that there is a multimedia message that an outgoing terminal intends to send.

After receiving the indicator message (M-Notification.ind), in step 512, the incoming MS 503 sends an indicator response message (M-Notifyresp.ind) to the indicator message to the multimedia message server 501.

After sending the indicator response message (M-Notifyresp.ind), in step 514, the incoming MS 503 sends a multimedia message request message (WSP/HTTPGet.req) to the multimedia message server 501 on the basis of information included in the indicator message (M-Nofitication.ind). Thus, in step 516, the incoming MS 503 receives a multimedia message sent by the outgoing terminal (M-Retrieve.conf).

In step 518, the incoming MS 503 sends the received multimedia message to the application 505 requiring the received multimedia message (i.e., an application corresponding to the received multimedia message). In step 520, the incoming MS 503 receives a response message indicative of reception or non-reception of the multimedia message from the application 505.

Accordingly, the incoming MS 503 sets an application response that is indicative of message reception or non-reception from the application 505.

Here, the application response is to address a problem of the conventional art in which, upon message or data transmission between a multimedia message and an application, if a received multimedia message cannot be delivered to the application because the application having a delivery of the multimedia message is not registered, because of an internal problem, or because of any other problem, the outgoing terminal sending the multimedia message cannot determine if the message is properly received by the application. So, the incoming MS 503 sets the application response to an existing multimedia message format or generates a new field in the existing multimedia message format, thus being able to inform if actual message delivery to the application is successfully carried out.

For example, if using the existing multimedia message format, the incoming MS 503 requests the message server 501 to send a success or failure of message delivery to the outgoing terminal, by adding an ‘X-Mms-Status’ used in an ‘M-NotiResp.ind’ and an ‘M-Delivery.ind’ to an ‘M-Acknowedge.ind’, adding a value suitable to the above conditions among status values of the ‘X-Mms-Status’, and sending a success or failure of message delivery to the message server 501.

If intending to define a new field in an existing multimedia message format and deliver a success or failure of message delivery to the application, in step 522, the incoming MS 503 identically adds a new field to the ‘M-Delivery.ind’, ‘M-NotiResp.ind’, and ‘M-Acknowledge.ind’, and delivers the ‘M-Delivery.ind’, ‘M-NotiResp.ind’, and ‘M-Acknowledge.ind’ to the multimedia message server 501. At this time, the incoming MS 503 may add a field such as “retrieved”, “unregistered”, and “unrecognized”.

As described above, exemplary embodiments of the present invention provide an apparatus and method for, upon multimedia message transmission, providing an interface state between a multimedia message and a corresponding application in a mobile communication system. By identifying if an incoming terminal receiving a multimedia message successfully delivers the received multimedia message to a corresponding application and delivering the identification result to an outgoing terminal, exemplary embodiments of the present invention may address a problem that, in a conventional mobile communication system, an outgoing terminal continuously sends an unnecessary multimedia message because it fails to determine if an incoming portable terminal delivers a multimedia message to an application.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for message transmission in a mobile communication system, the apparatus comprising:
an application manager for determining an application corresponding to a receive message, for sending the receive message to the determined application, and for determining a response to the message reception from the application; and
a message processor for setting a response informing that one of a message is delivered to the application and a message is not delivered to the application depending on an operation of the application manager.

2. The apparatus of claim 1, wherein the message processor sets the response informing that one of the message is delivered to the application and the message is not delivered to the application to one of an existing message format and a new field in the existing message format for setup.

3. The apparatus of claim 2, wherein the message processor delivers the response to the message reception from the application using at least one of an ‘M-NotiResp.ind’, an ‘M-Acknowledge.ind’, and an ‘M-Delivery.ind’.

4. The apparatus of claim 2, wherein the message processor sets a new field to an ‘M-NotiResp.ind’, an ‘M-Acknowledge.ind’, and an ‘M-Delivery.ind’.

5. The apparatus of claim 4, wherein the message processor adds a field comprising at least any one of “retrieved”, “unregistered”, and “unrecognized”.

6. The apparatus of claim 1, wherein the application manager determines the application required by the receive message by determining application information included in the receive message.

7. The apparatus of claim 1, wherein the message processor receives notification of the receive message, and requests transmission of the receive message.

8. The apparatus of claim 7, wherein the message processor acknowledges the receiving of the notification.

9. A method for message transmission in a mobile communication system, the method comprising:
determining an application corresponding to a receive message;
sending the receive message to the determined application;
if receiving a response to the message from the application, setting a response informing that the message is delivered to the application;
if not receiving a response to the message from the application, setting a response informing that the message is not delivered to the application; and
sending the set response to a message server.

10. The method of claim 9, wherein the response informing that the message is delivered to the application is set to one of an existing message format and a new field generated in the existing message format for setup.

11. The method of claim 9, wherein the response informing that the message is not delivered to the application is set to one of an existing message format and a new field generated in the existing message format for setup.

12. The method of claim 11, wherein the setting of the response to the existing message format delivers the response to the message reception from the application using at least any one of an ‘M-NotiResp.ind’, an ‘M-Acknowledge.ind’, and an ‘M-Delivery.ind’.

13. The method of claim 11, wherein the generating of the new field in the message format and setting the response generates the new field in an ‘M-NotiResp.ind’, an ‘M-Acknowledge.ind’, and an ‘M-Delivery.ind’.

14. The method of claim 12, wherein the field generated in the message format comprises at least any one of “retrieved”, “unregistered”, and “unrecognized”.

15. The method of claim 14, wherein the determining of the application required by the receive message comprises determining application information included in the receive message.

16. The method of claim 9, further comprising:
receiving notification of the receive message; and
requesting transmission of the receive message.

17. The method of claim 16, further comprising acknowledging the receiving of the notification.
